(19) United States
(12) Patent Application Publication
(10) Pub. No.: US 2009/0300704 A1
(43) Pub. Date: Dec. 3, 2009

(54) Presentity Rules for Location Authorization in a Communication System

(75) Inventors: Christer Boberg, Tungelsta (SE); Johan Bolin, Spanga (SE); Anders Lindgren, Alvsjo (SE)

Correspondence Address: POTOMAC PATENT GROUP PLLC, P. O. BOX 270, FREDERICKSBURG, VA, 22404, US

(73) Assignee: TELEFONAKTIEBOLAGET LM ERICSSON (PUBL), Stockholm (SE)

(21) Appl. No.: 12/127,443

(22) Filed: May 27, 2008

(51) Int. Cl. G06F 21/00

(52) U.S. Cl. 726/1

(57) ABSTRACT

A server, computer readable medium and method for accessing data related to a first user connected to a communication network that includes a server, the data being accessed by a second user connected to the communication network. The method includes receiving at the server instructions from the first user for generating authentication privileges for the second user to access the data of the first user, wherein the data includes at least one of location data related to a physical location of the first user, and presence data related to an availability of the first user to communicate with the second user; applying a single set of authentication rules to generate the authentication privileges for the second user for both the location data and the presence data; and storing the generated authentication privileges of the second user.

### TECHNICAL FIELD

The present invention generally relates to communication systems, devices, software and methods and, more particularly, to mechanisms and techniques for authorizing a user to receive information related to another user in a communication system.

### BACKGROUND

During the past years, the interest in using mobile and landline/wireline computing devices in day-to-day communications has increased. Desktop computers, workstations, and other wireline computers currently allow users to communicate, for example, via e-mail, video conferencing, and instant messaging (IM). Mobile devices, for example, mobile telephones, handheld computers, personal digital assistants (PDAs), etc. also allow the users to communicate via e-mail, video conferencing, IM, etc. Mobile telephones have conventionally served as voice communication devices, but through technological advancements they have recently proved to be effective devices for communicating data, graphics, etc. Wireless and landline technologies continue to merge into a more unified communication system, as user demand for seamless communications across different platforms increases.

Many communication applications allow for real-time or near real-time communication that falls outside of the traditional voice communication associated with wireline and wireless telephone communications. Chat sessions, instant messaging, Short Message Service (SMS), video conferencing, are a few such communication vehicles. Many of these types of communications are expected to become increasingly popular, particularly in view of the proliferation of wireless devices and continual technological breakthroughs.

In order to implement such technologies, the “presence” technology is used to determine the location, willingness to communicate, and other parameters relating to real-time or near real-time communications. The presence technology generally refers to applications and services that facilitate location and identification of one or more endpoints to such communication links. For example, if a first user of a wireless, handheld device, intends to initiate an IM session with a second IM user, presence services may be used to present the second user's willingness to receive IM messages. Presence services are an integral part of third generation (3G) wireless networks, and are intended to be employed across a wide variety of communication devices.

Presence information may be created at a presence server or an associated system. Presence information may be a status indicator that conveys the ability and willingness of a potential user to communicate with other users. The presence server may provide the presence information for distribution to other users (called watchers) to convey the availability of the user for communication. Presence information is used in many communication services, such as IM and recent implementations of voice over IP communications.

More specifically, a user client may publish a presence state to indicate its current communication status. This published state informs others that wish to contact the user of his availability and willingness to communicate. One use of presence is to display an indicator icon on IM clients, for example a choice of a graphic symbol with an easy-to-convey meaning, and a list of corresponding text descriptions of each of the states. This is similar to the “on-hook” or “off-hook” state of a fixed telephone.

Common states regarding the user's availability are “free for chat”, “busy”, etc. Such states exist in many variations across different modern instant messaging clients. However, the standards support a rich choice of additional presence attributes that may be used for presence information, such as user mood, location, or free text status.

Presence service is a network service which accepts, stores and distributes presence information. The presence service may be implemented as a single server or may have an internal structure involving multiple servers and proxies. There may be complex patterns of redirection and proxying while retaining logical connectivity to a single presence service. Also presence service may be implemented as direct communication among presentity and watchers, i.e., a server is not required.

A number of entities may be implemented in a presence service architecture. One of these entities is the presentity, which is an entity that provides presence information. Another entity is the presence server, which receives presence information from presentities. The watcher is an entity that is interested in the presence information.

The presence information (e.g., location, willingness to communicate at a certain time or with certain users, etc.) may be collected and utilized by presence servers, which may notify authorized “watchers” who are interested in certain presence information. Watcher applications may be implemented in wireline and/or wireless terminals to obtain presence information from the presence servers about other users. This may come in the form of a notification, issued to the watcher by the presence server.

Notifications to users/watchers that a targeted user/device has become available may be sent as complete or partial presence information. In other words, there are a number of different pieces of presence information that can be associated with the totality of the presence information. In a similar manner to the presence information and associated structure, there are location servers and location information regarding the users. The location information may include geographical location information.

Geographical location information describes a physical position that may correspond to the past, present, or future location of a person, event, or device. Numerous applications used in the Internet today benefit from sharing location information (including mapping/navigation applications, ‘friend finders’ on cell phones, and so on). However, such applications may disclose the whereabouts of a person in a manner contrary to the user's preferences. Privacy lapses may permit eavesdroppers to capture location information. The privacy concerns surrounding the unwanted disclosure of a person's physical location are among the more serious issues that confront users on the Internet. Consequently, access to the location information is governed by a set of rules established in part, by the user. The rules, which may be stored on the location server or another server, govern the access to the location information and the rules are independent of other rules governing other servers, for example the rules governing access to the presence information on the presence server.

Thus, the location of a user is a valuable piece of information that it is desirable to be protected from unauthorized usage and specific rules are applied to control who is allowed to see what data. Location data may often be used in relation to presence and combined together with other data in presence notifications sent to the watchers that are subscribing to the presence data of a user. Often this data is fetched by the presence service from a location server or the location server publishes the data to the presence server when applicable. Location data may also be accessed directly from the location server by other applications and/or users than the presence server. For the reasons discussed above, the location data has its own authorization rules, which are different and separate from the presence authorization rules.

Thus, a problem is that each of the location server and the presence server has its own set of rules to determine who is allowed to access data. The presence user (presentity) may determine the presence rules by creating a document in, for example, the Presence XDMS (XML data management server) containing specific rules for each presence attributes including the location information. Similarly, the user may determine the location rules by creating a document in another server. Thus, the user has to create two different authorization documents for location and presence data to have the authorizations work correctly. These different sets of rules for location and presence make the management of the location and presence information more difficult for the user.

Accordingly, it would be desirable to provide devices, systems and methods for location and presence based applications that avoid the afore-described problems and drawbacks.

### SUMMARY

The following exemplary embodiments provide a number of advantages and benefits relative to existing presence and/or location systems, devices and methods including, for example, the possibility to reduce the amount of authorization data and documents which are created and maintained by users, as well as to reduce the complexity of servers which use location data in association with presence. It will be appreciated by those skilled in the art, however, that the claims are not limited to those embodiments which produce any or all of these advantages or benefits and that other advantages and benefits may be realized depending upon the particular implementation.

According to an exemplary embodiment, there is a method for accessing data related to a first user connected to a communication network that includes a server, the data being accessed by a second user connected to the communication network. The method includes receiving at the server instructions from the first user for generating authentication privileges for the second user to access the data of the first user, wherein the data includes at least one of location data related to a physical location of the first user, and presence data related to an availability of the first user to communicate with the second user; applying a single set of authentication rules to generate the authentication privileges for the second user for both the location data and the presence data; and storing the generated authentication privileges of the second user.

According to another exemplary embodiment, there is a server administering access to data related to a first user connected to a communication network that includes the server, the data being accessed by a second user connected to the communication network. The server includes a processor configured to receive instructions from the first user for generating authentication privileges for the second user to access the data of the first user, wherein the data includes at least one of location data related to a physical location of the first user, and presence data related to an availability of the first user to communicate with the second user; and to apply a single set of authentication rules to generate the authentication privileges for the second user for both the location data and the presence data; and a memory configured to store the generated authentication privileges of the second user.

According to still another exemplary embodiment, there is a computer readable medium that stores computer executable instructions, which when executed by a processor of a server, cause the server to administer access to data related to a first user connected to a communication network that includes a server, the data being accessed by a second user connected to the communication network. The instructions include receiving at the server instructions from the first user for generating authentication privileges for the second user to access the data of the first user, wherein the data includes at least one of location data related to a physical location of the first user, and presence data related to an availability of the first user to communicate with the second user; applying a single set of authentication rules to generate the authentication privileges for the second user for both the location data and the presence data; and storing the generated authentication privileges of the second user.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic diagram of a communication system including a user terminal and various servers;

FIG. 2 shows the flow of data between various elements of the communication system according to an exemplary embodiment;

FIG. 3 shows the flow of data between various elements of the communication system according to another exemplary embodiment;

FIG. 4 is a flow diagram showing how authentication privileges are used to allow a user to address data regarding another user according to an exemplary embodiment;

FIG. 5 is a schematic diagram of a user terminal; and

FIG. 6 is a schematic diagram of a server.

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of presence and location servers discussed in the context of IM systems. However, the embodiments to be discussed next are not limited to these systems but may be applied to other communication systems.

Reference throughout the specification to “one embodiment” or “an embodiment” means that a particular feature, structure, or characteristic described in connection with an embodiment is included in at least one embodiment of the present invention. Thus, the appearance of the phrases “in one embodiment” or “in an embodiment” in various places throughout the specification are not necessarily all referring to the same embodiment. Further, the particular features, structures or characteristics may be combined in any suitable manner in one or more embodiments.

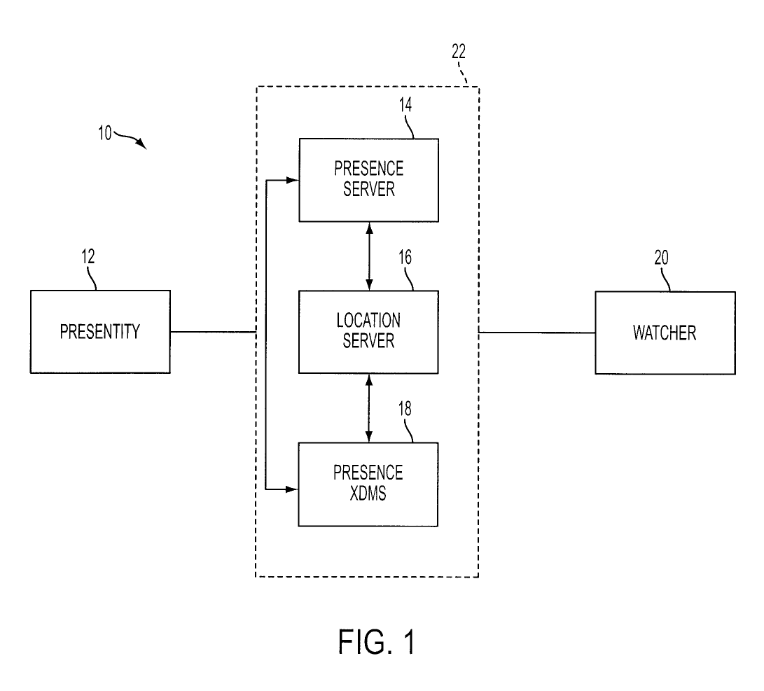

As shown in FIG. 1, according to an exemplary embodiment, a general communication system that uses location and presence data may include a presentity 12, a presence server 14, a location server 16, a presence XDMS server 18, and a watcher 20. The presence server 14, the location server 16, and the presence XDMS server 18 may be part of a single server 22 or may be implemented as separate servers located at separate physical locations. The presence server 14, the location server 16, and the presence XDMS server 18 may communicate directly to each other or via one of these servers as shown in FIG. 1. The communication path may be wireline or wireless. The presentity 12 and the watcher 20 may communicate with each of the presence server 14, the location server 16, and the presence XDMS server 18 or may communicate via a single port (not shown) with the single server 22. The communication of the presentity 12 and the watcher 20 with the servers may be wireline or wireless.

According to an exemplary embodiment, the presence authorization rules document that governs access to the presence information may be used to determine the authorization rules for the location information. The presence information may be stored on the presence server 14 and the location information may be stored in the location server 16. However, according to another exemplary embodiment, the presence information and the location information may be located on the same server. The presence rules may be used when accessing the location data via the presence server 14 and also when the location data is accessed directly via the location server 16. Using the same set of rules for two different types of data having different purposes and capabilities is not only applicable to location and presence data but to any type of presence data that is owned by an external entity and it is useful for PNA's (Presence Network Agents) such as a location server.

The presence and location servers will typically be unable to use the Shared Policy XDMS to implement the set of presence authorization rules described by these exemplary embodiments, because authorization for accessing their corresponding data is performed on an attribute/element level for these services, e.g., to perform call-setup and similar activities. Thus, another server that has semantic capabilities for processing access to both the location information and the presence information may be used to implement the set of rules according to these exemplary embodiments. One example of such server is the presence XDMS server. However, as will be recognized by those skilled in the art, other servers may be configured to handle access to both presence and location information. All such servers are generically referred to herein as “presence and location authorization rules servers” as described in more detail below. In this respect, the presence and location data may be considered as being part of a set of data having various attributes. For example, the presence data has a first attribute, the location data has a second attribute, service related data (e.g., voice service) has a third attribute. In this example, the server handles, based on a single set of rules, access to data having different attributes. The value of each attribute determines which kind of data is accessed. In other words, a first user using a same set of rules, may decide that a second user has access privileges for any data having attribute “a” but not to data having attribute “b.” In this example, attribute “a” may characterize presence data and attribute “b” may characterize location data.

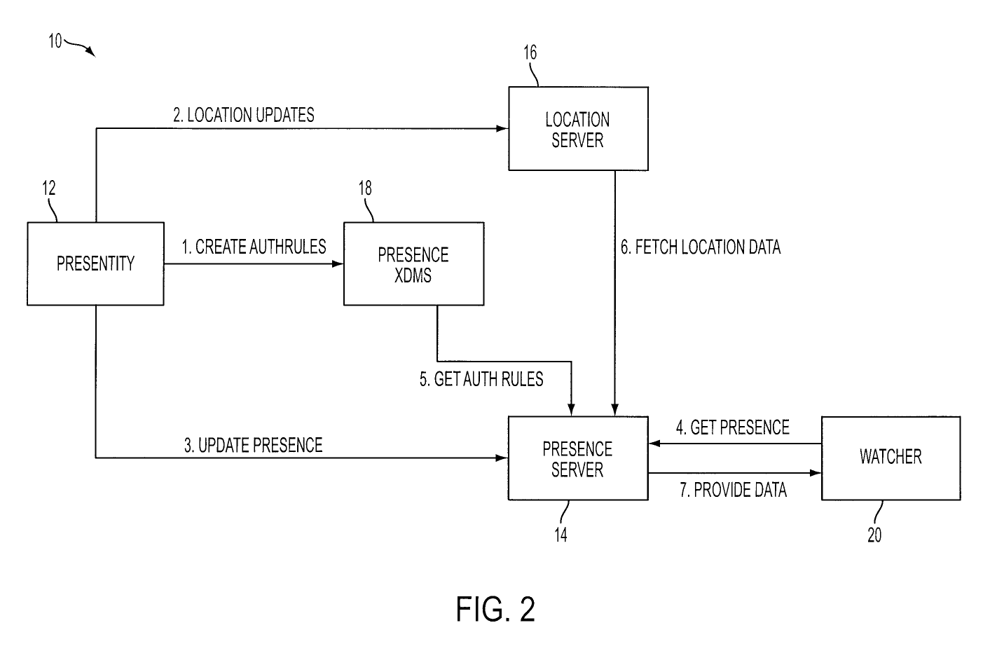

According to another exemplary embodiment, FIG. 2 shows an interaction among the various components of the communication system 10. More specifically, the watcher 20 fetches presence data from the presentity 12 and this data includes location data. The watcher 20 may explicitly have pointed out location data or just queries for all data for the presentity. The presence server 14 uses the authentication privileges stored in the Presence XDMS server 18, which have been created by the presentity 12 to determine whether the watcher 20 is allowed to see this particular information.

The flow of information among the components of the communication system 10 is discussed next. In step 1, the presentity 12 creates the authorization privileges for the presence data based on the single set of authentication rules, including specific information for the location related information. The location data authorization information may follow the general rules defined by the presence rules document just as any other presence data. In fact, the user, using a single set of rules, those of the presence data, may define different classes of access for the various watchers by using the different attributes of the data. The classes of access may be, for example, full access to all data, access only to the location data, access only to the presence data, etc. The authentication rules established by the presentity 12 may be generated and stored in the presence XDMS server 18.

In step 2, the location server 16 updates the current location information of the user/terminal 12. This may be a continuous procedure and possible mechanisms for keeping track of the current location are not within the scope of these embodiments. In step 3, the presentity 12 may send updated presence data to the presence server 14. This data may include parts of the location information or may just be another type of presence data. In step 4, the watcher 20 decides to fetch/subscribe to the presence data of the presentity 12. In this case, the watcher 20 may explicitly state that the location information of presentity 12 is of interest. It is noted that for the simplicity of the discussion, a single presentity 12 and a single watcher 20 are shown. However, the techniques and methods discussed here are also applicable to a system that includes plural presentities, watchers and servers.

Based on the request received in step 4 by the presence server 14 from the watcher 20, the presence server 14 checks the presence authorization privileges, i.e., whether the watcher 20 is allowed to see any data of the presentity 12. The presence server may also check at this time whether the watcher 20 is authorized to see the location data of the presentity 12. However, this last check may be performed after the next step, when the presence server 14 has fetched the information from the location server 16.

Supposing that the watcher 20 is a “buddy” to the presentity 12, i.e., it is authorized to see the location data of the presentity 12, the presence server 14 fetches in step 6 the location data of the presentity 12 from the location server 16. In another exemplary embodiment, the location data may already be known by the presence server 14, prior to step 6, depending on the procedure used by the presence server 14 for obtaining the location data. The location data is combined together with any other existing/requested presence data and sent to the watcher 20 in step 7.

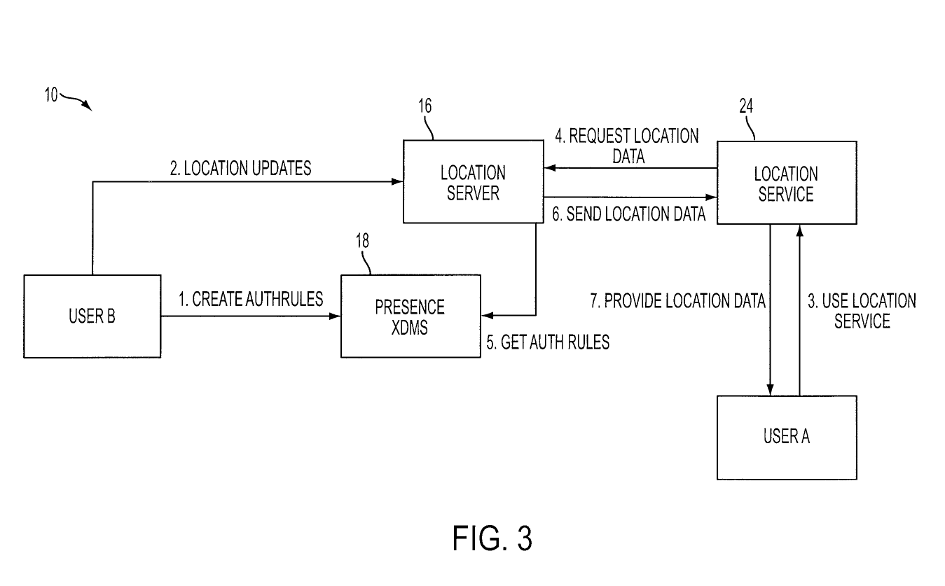

According to another exemplary embodiment shown in FIG. 3, a user A uses a location based service 24, which is dependent on the location information of another user B. How the authorization information of the Presence XDMS is used for accessing the location information of user B is discussed next. FIG. 3 shows that in step 1, user B creates the authorization privileges for presence, including specific information for the location related information. The authorization privileges may be generated and stored in the presence XDMS server 18 based on a single set of presence authorization rules. In step 2, the location server 16 maintains the current location information of user B, i.e., a terminal used by a physical user. As discussed in a previous exemplary embodiment, this may be a continuous procedure.

In step 3, user A decides to use the location based service 24, which is dependent on the location information of user B. Thus, user A requests from the location service 24 the location data of user B. In step 4, the location service 24 requires the location information of user B from the location server 16. The location server 16 checks in step 5 the presence authorization privileges established by user A to determine whether user A has allowed user B to see its location data. The presence authorization privileges are checked in the presence XDMS server 18 by the location server 16. It is noted that in this example no presence server is involved in the communication of the various components of the communication system 10. Supposing that user A was authorized to receive the location data of user B, the location server 16 returns the location data to the location service in step 6, and the location service 24 provides this location data of user B to user A in step 7. In one exemplary embodiment, user A is authorized by the location service 24 to see the location data of user B.

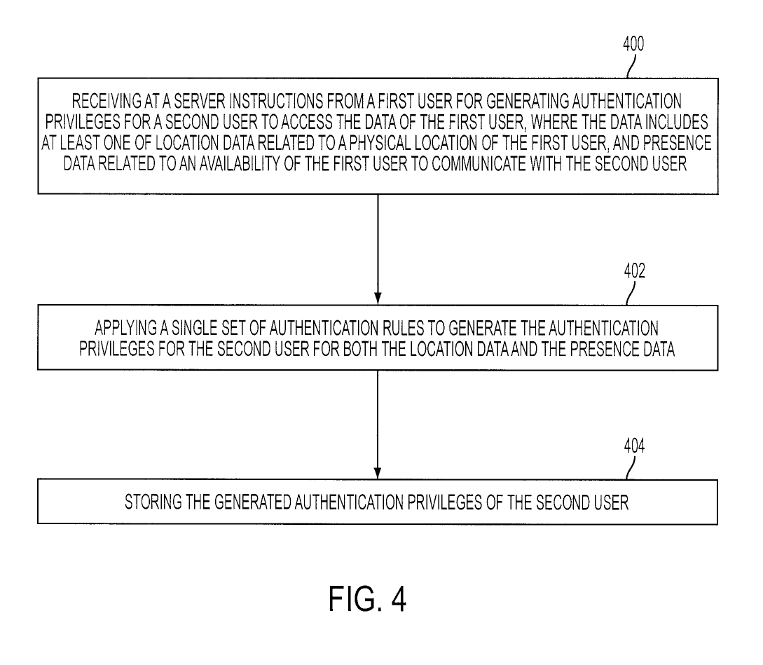

According to another exemplary embodiment, a processor of a server may be configured for accessing data related to a first user connected to a communication network that includes the server, the data being accessed by a second user connected to the communication network. As shown in FIG. 4, in step 400 the server receives instructions from the first user for generating authentication privileges for the second user to access data of the first user, wherein the data includes location data related to a physical location of the first user, and presence data related to an availability of the first user to communicate with the second user. In step 402, the server applies a single set of authentication rules to generate the authentication privileges for the second user and in step 404 the server stores the generated authentication privileges of the second user.

According to one or more of the novel methods and techniques discussed above, the amount of authorization data and the number of authorization documents that are created by the user and maintained by the server are reduced, the complexity for the presence server using location data in connection to presence is reduced, and the complexity for the location server using location data in connection to presence is also reduced.

Terminals that may act as presentity and/or watchers as described in connection with the exemplary embodiments may be desktop/personal computers, workstations, large-scale computing terminals, wireless terminals, or any other computing device capable of executing presence awareness applications. The wireless terminals may include devices such as wireless/cellular telephones, personal digital assistants (PDAs), or other wireless handsets, as well as portable computing devices. The mobile terminals may utilize computing components to control and manage the conventional device activity as well as the functionality provided by the exemplary embodiments. Hardware, firmware, software or a combination thereof may be used to perform the various methods and techniques described in this document.

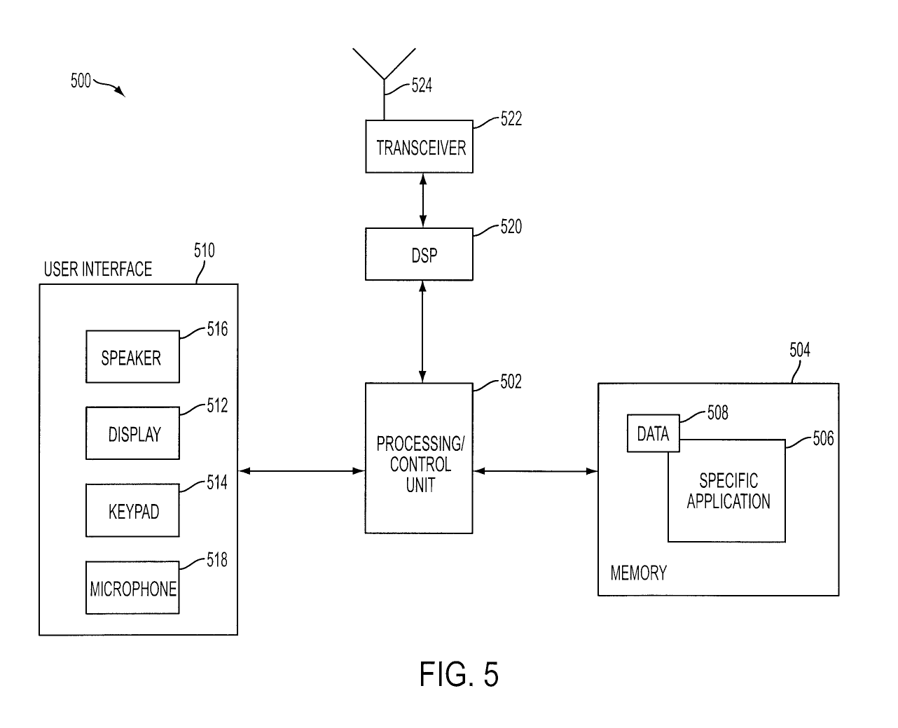

For purposes of illustration and not of limitation, an example of a representative mobile terminal computing system capable of carrying out operations in accordance with the exemplary embodiments is illustrated in FIG. 5. It should be recognized, however, that the principles of the present exemplary embodiments are equally applicable to standard computing systems.

The exemplary mobile computing arrangement 500 may include a processing/control unit 502, such as a microprocessor, reduced instruction set computer (RISC), or other central processing module. The processing unit 502 need not be a single device, and may include one or more processors. For example, the processing unit 502 may include a master processor and associated slave processors coupled to communicate with the master processor.

The processing unit 502 may control the basic functions of the mobile terminal as dictated by programs available in the storage/memory 504. Thus, the processing unit 502 may execute the functions described in FIGS. 2 and 3. More particularly, the storage/memory 504 may include an operating system and program modules for carrying out functions and applications on the mobile terminal. For example, the program storage may include one or more of read-only memory (ROM), flash ROM, programmable and/or erasable ROM, random access memory (RAM), subscriber interface module (SIM), wireless interface module (WIM), smart card, or other removable memory device, etc. The program modules and associated features may also be transmitted to the mobile computing arrangement 500 via data signals, such as being downloaded electronically via a network, such as the Internet.

One of the programs that may be stored in the storage/memory 504 is a specific program 506. As previously described, the specific program 506 may interact with a location server and/or a presence server to fetch and/or subscribe to presence information of one or more presentities. The program 506 and associated features may be implemented in software and/or firmware operable by way of the processor 502. The program storage/memory 504 may also be used to store data 508, such as the various authentication rules, or other data associated with the present exemplary embodiments. In one exemplary embodiment, the programs 506 and data 508 are stored in non-volatile electrically-erasable, programmable ROM (EEPROM), flash ROM, etc. so that the information is not lost upon power down of the mobile terminal 500.

The processor 502 may also be coupled to user interface 510 elements associated with the mobile terminal. The user interface 510 of the mobile terminal may include, for example, a display 512 such as a liquid crystal display, a keypad 514, speaker 516, and a microphone 518. These and other user interface components are coupled to the processor 502 as is known in the art. The keypad 514 may include alpha-numeric keys for performing a variety of functions, including dialing numbers and executing operations assigned to one or more keys. Alternatively, other user interface mechanisms may be employed, such as voice commands, switches, touch pad/screen, graphical user interface using a pointing device, trackball, joystick, or any other user interface mechanism.

The mobile computing arrangement 500 may also include a digital signal processor (DSP) 520. The DSP 520 may perform a variety of functions, including analog-to-digital (A/D) conversion, digital-to-analog (D/A) conversion, speech coding/decoding, encryption/decryption, error detection and correction, bit stream translation, filtering, etc. The transceiver 522, generally coupled to an antenna 524, may transmit and receive the radio signals associated with a wireless device.

The mobile computing arrangement 500 of FIG. 5 is provided as a representative example of a computing environment in which the principles of the present exemplary embodiments may be applied. From the description provided herein, those skilled in the art will appreciate that the present invention is equally applicable in a variety of other currently known and future mobile and fixed computing environments. For example, the specific application 506 and associated features, and data 508, may be stored in a variety of manners, may be operable on a variety of processing devices, and may be operable in mobile devices having additional, fewer, or different supporting circuitry and user interface mechanisms. It is noted that the principles of the present exemplary embodiments are equally applicable to non-mobile terminals, i.e., landline computing systems.

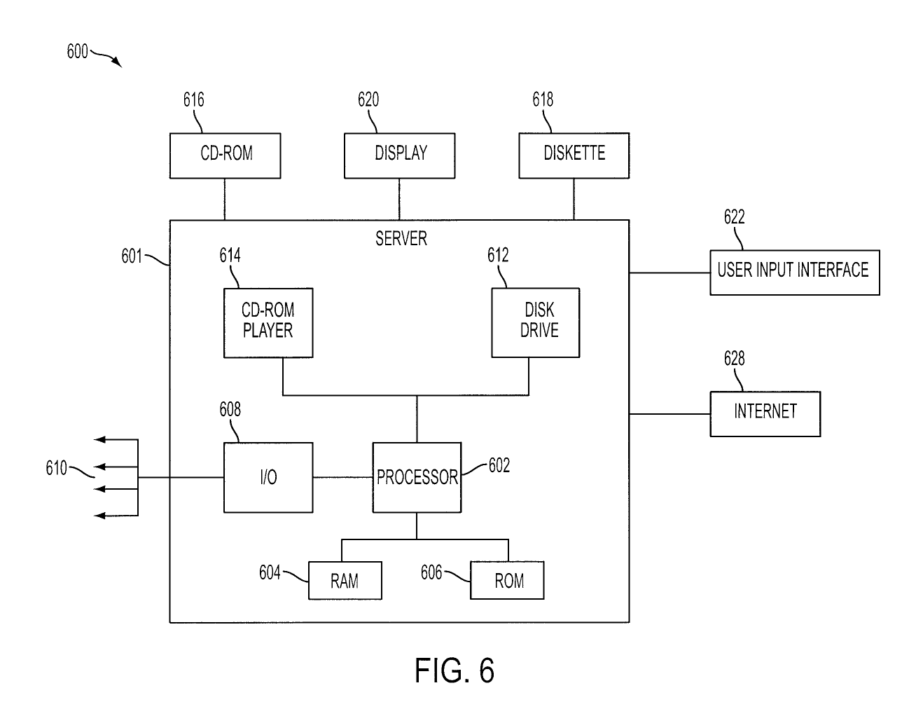

The presence, location and/or presence XDMS servers or other systems for providing presence and location information in connection with the present exemplary embodiments may be any type of computing device capable of processing and communicating presence information. An example of a representative computing system capable of carrying out operations in accordance with the servers of the exemplary embodiments is illustrated in FIG. 6. Hardware, firmware, software or a combination thereof may be used to perform the various steps and operations described herein. The computing structure 600 of FIG. 6 is an exemplary computing structure that may be used in connection with such a system.

The exemplary computing arrangement 600 suitable for performing the activities described in the exemplary embodiments may include a presence server or a location server or a presence XDMS server 601. Such a server 601 may include a central processor (CPU) 602 coupled to a random access memory (RAM) 604 and to a read-only memory (ROM) 606. The ROM 606 may also be other types of storage media to store programs, such as programmable ROM (PROM), erasable PROM (EPROM), etc. The processor 602 may communicate with other internal and external components through input/output (I/O) circuitry 608 and bussing 610, to provide control signals and the like. The processor 602 carries out a variety of functions as is known in the art, as dictated by software and/or firmware instructions.

The server 601 may also include one or more data storage devices, including hard and floppy disk drives 612, CD-ROM drives 614, and other hardware capable of reading and/or storing information such as DVD, etc. In one embodiment, software for carrying out the above discussed steps may be stored and distributed on a CD-ROM 616, diskette 618 or other form of media capable of portably storing information. These storage media may be inserted into, and read by, devices such as the CD-ROM drive 614, the disk drive 612, etc. The server 601 may be coupled to a display 620, which may be any type of known display or presentation screen, such as LCD displays, plasma display, cathode ray tubes (CRT), etc. A user input interface 622 is provided, including one or more user interface mechanisms such as a mouse, keyboard, microphone, touch pad, touch screen, voice-recognition system, etc.

The server 601 may be coupled to other computing devices, such as the landline and/or wireless terminals and associated watcher applications, via a network. The server may be part of a larger network configuration as in a global area network (GAN) such as the Internet 628, which allows ultimate connection to the various landline and/or mobile client/watcher devices.

The disclosed exemplary embodiments provide a user terminal, a system, a method and a computer program product for obtaining location data of a certain user. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

For example, although the foregoing exemplary embodiments describe that the single set of authentication rules (e.g., the rules used to generate the authentication privileges for a user for both the location data and the presence data) can be stored according to one exemplary embodiment on a presence data management server, it will be appreciated that the particular name and/or location of the server which stores the single set of rules can be varied. For example, this server could also be referred to as a “presence and location authorization rules server”. The server, regardless of its name, could be dedicated to the storage of such rule sets or, alternatively, could also be used to store other, e.g., similar, data. In the latter case, the server could then be referred to, for example, as a “content based authorization rules server”. For the purposes of this specification, the term “presence and location authorization rules server” shall be generic to all such servers which may be used to store the rule sets described herein.

Although the features and elements of the present exemplary embodiments are described in the embodiments in particular combinations, each feature or element can be used alone without the other features and elements of the embodiments or in various combinations with or without other features and elements disclosed herein. The methods or flow charts provided in the present application may be implemented in a computer program, software, or firmware tangibly embodied in a computer-readable storage medium for execution by a general purpose computer or a processor.

What is claimed is:

1. A method for accessing data related to a first user connected to a communication network that includes a server, the data being accessed by a second user connected to the communication network, the method comprising:
receiving at the server instructions from the first user for generating authentication privileges for the second user to access the data of the first user, wherein the data includes at least one of location data related to a physical location of the first user, and presence data related to an availability of the first user to communicate with the second user;
applying a single set of authentication rules to generate the authentication privileges for the second user for both the location data and the presence data; and
storing the generated authentication privileges of the second user.

2. The method of claim 1, further comprising:
receiving at the server a request from the second user to obtain specific data of the first user, wherein the specific data includes location data, presence data or both of them.

3. The method of claim 2, further comprising:
verifying the authentication privileges of the second user to determine whether the second user has access to the location data, presence data or both of them.

4. The method of claim 3, further comprising:
providing the second user with the requested specific data of the first user when the second user has the authorization privileges.

5. The method of claim 1, further comprising:
updating the presence data of the first user in a presence server of the server.

6. The method of claim 1, further comprising:
updating the location data of the first user in a location server of the server.

7. The method of claim 1, further comprising:
retrieving the single set of authorization rules from a presence and location authorization rules server.

8. The method of claim 1, further comprising:
retrieving the location data from a location server within the server.

9. The method of claim 1, wherein the server includes a presence and location authorization rules server, a presence server and a location server.

10. A server administering access to data related to a first user connected to a communication network that includes the server, the data being accessed by a second user connected to the communication network, the server comprising:
a processor configured to receive instructions from the first user for generating authentication privileges for the second user to access the data of the first user, wherein the data includes at least one of location data related to a physical location of the first user, and presence data related to an availability of the first user to communicate with the second user; and to apply a single set of authentication rules to generate the authentication privileges for the second user for both the location data and the presence data; and
a memory connected to the processor and configured to store the generated authentication privileges of the second user.

11. The server of claim 10, wherein the processor is further configured to:
receive a request from the second user to obtain specific data of the first user, wherein the specific data includes location data, presence data or both of them.

12. The server of claim 11, wherein the processor is further configured to:
verify the authentication privileges of the second user to determine whether the second user has access to the location data, presence data or both of them.

13. The server of claim 12, wherein the processor is further configured to:
provide the second user with the requested specific data of the first user when the second user has the authorization privileges.

14. The server of claim 10, further comprising:
a presence server configured to update the presence data of the first user.

15. The server of claim 10, further comprising:
a location server configured to update the location data of the first user.

16. The server of claim 10, further comprising:
a presence and location authorization rules server configured to maintain the single set of authorization rules.

17. The server of claim 10, further comprising:
a presence and location authorization rules server, a presence server and a location server.

18. A computer readable medium that stores computer executable instructions, which when executed by a processor of a server, cause the server to administer access to data related to a first user connected to a communication network that includes a server, the data being accessed by a second user connected to the communication network, the instructions comprising:
receiving at the server instructions from the first user for generating authentication privileges for the second user to access the data of the first user, wherein the data includes at least one of location data related to a physical location of the first user, and presence data related to an availability of the first user to communicate with the second user;
applying a single set of authentication rules to generate the authentication privileges for the second user for both the location data and the presence data; and
storing the generated authentication privileges of the second user.

19. The medium of claim 18, further comprising:
receiving at the server a request from the second user to obtain specific data of the first user, wherein the specific data includes location data, presence data or both of them.

20. The medium of claim 19, further comprising:
verifying the authentication privileges of the second user to determine whether the second user has access to the location data, presence data or both of them.

21. The medium of claim 20, further comprising:
providing the second user with the requested specific data of the first user when the second user has the authorization privileges.

22. The medium of claim 18, further comprising:
updating the presence data of the first user in a presence server of the server.

23. The medium of claim 18, further comprising:
updating the location data of the first user in a location server of the server.

24. The medium of claim 18, further comprising:
retrieving the single set of authorization rules from a presence and location authorization rules server.

25. The medium of claim 18, further comprising:
retrieving the location data from a location server within the server.

26. The medium of claim 18, wherein the server includes a presence and location authorization rules server, a presence server and a location server.

27. A server administering access to data related to a first user connected to a communication network that includes the server, the data being accessed by a second user connected to the communication network, the server comprising:
means for receiving instructions from the first user for generating authentication privileges for the second user to access the data of the first user, wherein the data includes at least one of location data related to a physical location of the first user, and presence data related to an availability of the first user to communicate with the second user; and to apply a single set of authentication rules to generate the authentication privileges for the second user for both the location data and the presence data; and
means for storing the generated authentication privileges of the second user.
